(19) United States
(12) Patent Application Publication
(10) Pub. No.: US 2003/0067535 A1
(43) Pub. Date: Apr. 10, 2003

(54) System and method for component TV system

(75) Inventors: Anthony Lionel Creed, San Diego, CA (US); Greg Gudorf, San Diego, CA (US); Aaron Dew, San Diego, CA (US); Matthew Chang, San Diego, CA (US); William Hausch, Culver City, CA (US)

Correspondence Address: John L. Rogitz, Rogitz & Associates, Suite 3120, 750 B Street, San Diego, CA, 92101, US

(73) Assignee: SONY CORPORATION, Tokyo (JP)

(21) Appl. No.: 09/972,516

(22) Filed: Oct. 5, 2001

(51) Int. Cl. H04N 7/14

(52) U.S. Cl. 348/14.04; 348/14.01; 348/14.02

(57) ABSTRACT

A componentized TV system having a video display and audio speakers in wireless communication with a computer. The computer adjusts the audio settings of the speakers based on their distance to the display to optimize the listening experience.

### BACKGROUND OF THE INVENTION

1. Field of the Invention

The present invention relates generally to television systems.

2. Description of the Related Art

Televisions and computers have become ubiquitous, and since both usually entail a visual display, efforts have been made to integrate both functions into a single system. In this way, a consumer need not purchase and operate two separate systems, which can burden some consumers who, while familiar with operating a television and its remote control, might not be familiar with operating, e.g., an Internet computer.

To the extent that attempts have been made to combine television with Internet features, it has generally been with the focus of producing what might be thought of as a “lean forward” system. That is, hybrid TV/computers have typically been more oriented toward productivity, generally thought of as a computer system characteristic, and less toward entertainment (“lean back”), generally regarded as a television system characteristic. It is not just the dichotomy between productivity and entertainment that distinguishes a “lean forward” experience from a “lean back” experience, however. As contemplated herein, “lean forward” activities often are experienced by only a single person, while “lean back” activities are often group experiences. Moreover, “lean back” activities can extend to purchasing products that are advertised on TV, as opposed to, e.g., making products for sale. In any case, with the above-mentioned critical observation of the present invention in mind, it can readily be appreciated that the differences between a system designed for “lean forward” experiences and a system designed for “lean back” experiences can be both subtle and profound.

An example of a “lean forward” system is the system known as “WebTV”, in which preselected Internet pages are loaded once into a television during manufacture and never subsequently updated, with the preselected pages being accessible through the television using a computer keyboard with its attendant complexity. To access the pages, the consumer must access a central site by means of the keyboard, and then be redirected to a desired Web page. In terms of currently expected speeds of Internet access, this consumes an undue amount of time. Furthermore, it requires browser or browser-like operations that must be executed by a consumer. All of these features—use of a keyboard, knowledgeable use of a browser, and wait time for Web page access—are not per se unacceptable for a lean forward experience, but would severely detract from a lean back experience.

For instance, in the context of lean back, entertainment- and group-oriented experiences, consumers are accustomed to using a much simpler input device than a computer keyboard, namely, a remote control. Moreover, a user interface that is simpler than a Web browser, e.g., an electronic program guide (EPG), is preferred. Also, waiting for entertainment to load or otherwise be prepared for playing is distracting in a lean-back, group-oriented experience. But as exemplified above by the WebTV system, current systems that attempt to integrate television and computers essentially do so by grafting a TV onto what is essentially an underlying, lean forward computer system, and consequently provide less than optimum lean back experiences.

As an example, it might be desirable to enable a viewer to place a TV anywhere in a dwelling that the viewer happens to want to watch the TV, and to continue to move the viewing screen as the viewer moves. For example, a viewer in a bedroom might want to lay in bed in one position to watch a TV, and then move to another position to watch the TV, and it would be desirable to allow the viewer to easily reposition the TV screen accordingly. However, current portable TV systems typically include a single housing that contains all TV system components and that consequently is too large to constantly reposition easily, or is so small that the screen is also very small, making viewing difficult for many people. The object of the present invention is to provide a TV system that accommodates lean back experiences better than existing systems.

### SUMMARY OF THE INVENTION

A TV system includes a portable video display and one or more audio speakers. A computer is in wireless communication with the display and speaker. The computer causes the display to present TV video and the speaker to present TV audio associated with the video. In this way, a viewer can move the display to any desired location in a room, and the computer will adjust the speaker volume or other audio settings, e.g., tone, EQ, balance of a surround sound system, etc., accordingly to maintain an appropriate optimum sound. For instance, as the viewer moves “in front” of a surround sound system the settings of the speakers can change accordingly, with the “rear” speakers becoming the “front” speakers and vice-versa. In a preferred embodiment, the computer establishes the speaker volume based on the distance between the speaker and display.

To enable this, a position generator communicates signals to the computer based on which the computer establishes the volume. The position generator can be a global positioning system, phased micro array, ultrasonic generator, or electromagnetic waveform generator. A movable TV stand can be provided for supporting the display.

In another aspect, a method for presenting TV audio and video signals includes presenting the TV video signals on a portable display, and presenting the audio signals on at least one speaker distanced from the display and not connected to the display via a wire. The method further includes establishing a volume of the audio signals using a computer in wireless communication with the speaker.

In still another aspect, a wireless TV system includes a video display, a computer associated with the display, and at least one speaker. A wireless communication path is between the display and speaker, and/or the display and computer, and/or the computer and speaker. In any case, the computer establishes a volume for the speaker based on the distance between the display and speaker.

### BRIEF DESCRIPTION OF THE DRAWINGS

The details of the present invention, both as to its structure and operation, can best be understood in reference to the accompanying drawings, in which like reference numerals refer to like parts, and in which:

FIG. 1 is a block diagram of the system of the present invention; and

FIG. 2 is a flow chart of the present logic.

### DETAILED DESCRIPTION OF THE PREFERRED EMBODIMENTS

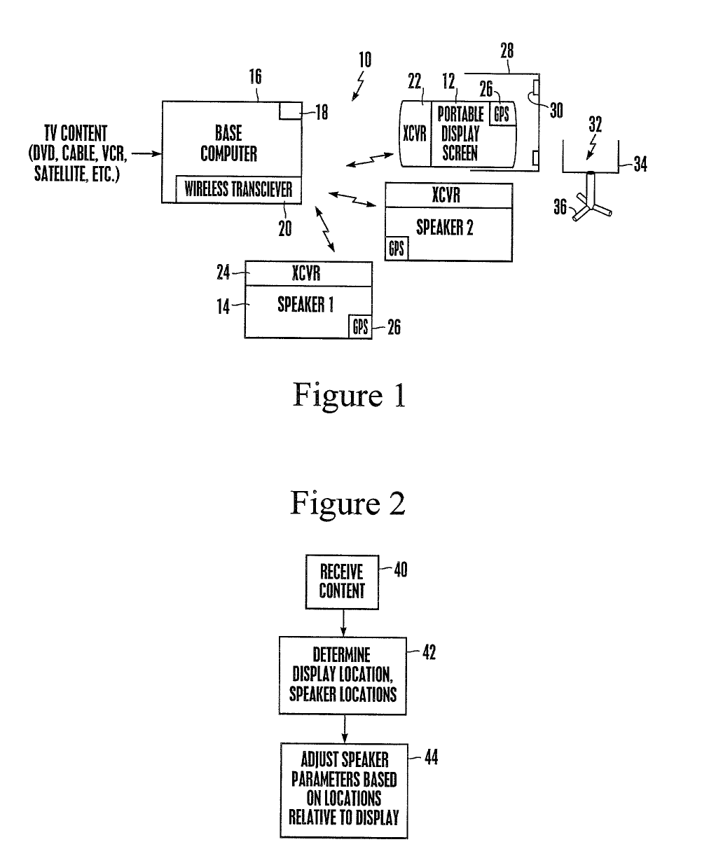

Referring initially to FIG. 1, a TV system is shown, generally designated 10. As shown, the system 10 includes a portable TV video display 12. The TV display 12 can be a cathode ray tube (CRT), flat panel matrix display, projection screen, or other appropriate video presentation device. Regardless of the specific type of display, it is portable, so that a person can easily move the display around a dwelling to a desired location.

Also, the system 10 includes one or more audio speakers 14 for playing TV audio that is associated with the TV video shown on the display 12. The speakers 14 are spaced from the display 12 and are not connected to the TV display 12 by wires. Owing to the below-described features, the speakers 14 need not be movable or moved with the display 12. Only the display 12 need be moved by a viewer. In one non-limiting embodiment, three or more speakers 14 can be provided in a surround sound configuration.

A computer 16 is also included in the system 10. As shown, the computer 16 is physically spaced from the speakers 14 and display 12, in wireless communication with both. It is to be understood, however, that the computer 16 could be housed with the display 12, in which case it would be in wireless communication with the speakers 14, or the computer 16 could be housed with one of the speakers 14, in which case it would be in wireless communication with the display 12 and remaining speakers 14.

In any case, the computer 16 receives TV signals, and so it is associated with a conventional TV tuner 18. The computer 16 can be any appropriate processing device. To enable wireless communication, the computer 16 includes a computer transceiver 20, while the display 12 includes a display transceiver 22 and the speakers 14 include respective speaker transceivers 24. The transceivers 20, 22, 24 are configured to communicate with each other via wireless link such as but not limited to rf link, IR link, or ultrasonic link.

Regardless of the specific type of link, the computer 16 receives TV signals including audio and video components and causes the display 12 to present TV video and the speakers 14 to present TV audio that is associated with the video. It is to be understood that the present principles apply more generally to a computer that receives audio video signals from any source, including TV tuners, VCRs, etc.

Additionally, for purposes to be shortly disclosed one or all of the display 12 and speakers 14 include respective position generators that communicate signals via their respective transceivers 22, 24 to the computer 16. Based on these signals, the computer 16 establishes the volume of the speakers 14.

In the exemplary non-limiting embodiment shown in FIG. 1, the position generators are respective global positioning systems 26. Alternatively, the position generators can be phased micro arrays or ultrasonic generators or electromagnetic waveform generators, the signals from which are received by the computer 16 and triangulated or otherwise processed to determine speaker 14 positions vis-a-vis display 12 position.

A TV stand 28 can be used to support the display 12. In one embodiment the stand 28 is a bracket that is mounted to a wall by means of fasteners 30. The bracket supports the display 12 above the viewer. Or, a movable stand 32 can be used to support the display 12. The stand 32 has an articulating display support 34 mounted on rollers 36. In this way, a viewer can push the display 12 to a desired location and then orient the support 34 as desired for easy viewing.

As set forth further below, in the presently preferred embodiment the computer 16 establishes the speaker 14 volumes based on the distance between the speakers 14 and the display 12. It is to be understood that the computer 16 executes some or all of the logic below. The flow charts herein illustrate the structure of the logic modules of the present invention as embodied in computer program software. Those skilled in the art will appreciate that the flow charts illustrate the structures of logic elements, such as computer program code elements or electronic logic circuits, that function according to this invention. Manifestly, the invention is practiced in its essential embodiment by a machine component that renders the logic elements in a form that instructs a digital processing apparatus (that is, a computer or microprocessor) to perform a sequence of function steps corresponding to those shown. Internal logic could be as simple as a state machine.

In other words, the present logic may be established as a computer program that is executed by a processor within, e.g., the present microprocessors/servers as a series of computer-executable instructions. In addition to residing on hard disk drives, these instructions may reside, for example, in RAM of the appropriate computer, or the instructions may be stored on magnetic tape, electronic read-only memory, or other appropriate data storage device.

Now referring to FIG. 2, at block 40 content in the form of TV signals, VCR data, or other audio video source data is received by the computer 16. Proceeding to block 42, the computer 16 determines at least the distance between the display 12 and each speaker 14, in accordance with the disclosure above. More generally, the computer 16 determines the location of the speakers 14 vis-a-vis the display 12. That is, not only distance, but orientation between the speakers 14 and display 12, can be used. With the location information, the logic moves to block 44 to establish the audio settings such as the volume of the speakers 14 based on their locations relative to the display 12.

Preferably, the computer 16 is programmed such that the further the distance between a speaker 14 and the display 12, the louder the volume of the speaker 14 that is established by the computer 12. Likewise, the closer the distance between a speaker 14 and the display 12, the lower the volume of the speaker 14. In one non-limiting example, the relationship between distance and volume is linear. In another embodiment, the relationship between distance and volume is squared, to account for spherical spreading. That is, the volume of a first speaker 14 that is twice the distance from the display 12 as is a second speaker 14 will be four times the volume of the second speaker. Other audio settings of the speakers 14 can likewise be established if desired based on the relative locations of the speakers 14 with respect to the display 12.

In a surround sound configuration, the system can adapt to viewer movement relative to the speakers 14. For instance, in one viewer orientation it might be desirable that “speaker 1” be the “front” speaker and “speaker 2” be the rear speaker. As the viewer moves, “speaker 1” and “speaker 2” can gradually exchange their roles in proportion to the speed of viewer motion. In more complex embodiments a virtual center of the speaker system can be established with the viewer at the center or at a predetermined location relative to the center, with the speaker settings being varied to maintained the viewer's position and orientation relative to the “center” constant. Thus, for instance, for a viewer who might lay down, a ceiling-mounted speaker might become the “front” speaker of the system.

While the particular SYSTEM AND METHOD FOR COMPONENT TV SYSTEM as herein shown and described in detail is fully capable of attaining the above-described objects of the invention, it is to be understood that it is the presently preferred embodiment of the present invention and is thus representative of the subject matter which is broadly contemplated by the present invention, that the scope of the present invention fully encompasses other embodiments which may become obvious to those skilled in the art, and that the scope of the present invention is accordingly to be limited by nothing other than the appended claims, in which reference to an element in the singular means “at least one”. All structural and functional equivalents to the elements of the above-described preferred embodiment that are known or later come to be known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. §112, sixth paragraph, unless the element is expressly recited using the phrase “means for”.

We claim:

1. A TV system, comprising:
at least one video display;
at least one audio speaker; and
at least one computer in wireless communication with the display and speaker,
the computer causing the display to present TV video and the speaker to present TV audio associated with the video.

2. The system of claim 1, wherein the computer establishes at least a speaker setting based at least in part on a distance between the speaker and display.

3. The system of claim 2, further comprising at least one position generator communicating signals to the computer based on which the computer establishes the setting.

4. The system of claim 3, wherein the position generator includes at least one global positioning system.

5. The system of claim 1, further comprising at least one movable TV stand supporting the display.

6. The system of claim 3, wherein the position generator includes at least one phased micro array.

7. The system of claim 3, wherein the position generator includes at least one ultrasonic generator or at least one electromagnetic waveform generator.

8. A method for presenting TV audio and video signals, comprising:
presenting the TV video signals on a portable display;
presenting the audio signals on at least one speaker distanced from the display and not connected thereto via a wire; and
establishing at least a setting of the audio signals using at least one computer in wireless communication with at least the speaker.

9. The method of claim 8, wherein the computer establishes at least a speaker setting based at least in part on a distance between the speaker and display.

10. The method of claim 9, further comprising communicating position signals to the computer based on which the computer establishes the setting.

11. A system for presenting TV audio and video signals, comprising the acts of:
portable means for presenting the TV video signals;
speaker means for presenting the audio signals, the speaker means being distanced from the portable means and not connected thereto via a wire; and
means for establishing at least a setting of the audio signals based at least in part on a distance between the speaker means and portable means.

12. The system of claim 11, further comprising means for communicating position signals to the means for establishing for undertaking the establishing act.

13. The system of claim 12, wherein the means for communicating position signals includes at least one global positioning system.

14. The system of claim 11, further comprising at least one movable TV support means supporting the portable means.

15. The system of claim 12, wherein the means for communicating includes at least one phased micro array.

16. The system of claim 12, wherein the means for communicating includes at least one ultrasonic generator or at least one electromagnetic waveform generator.

17. A wireless TV system, comprising:
a video display;
a computer associated with the display;
at least one speaker; and
at least one wireless communication path between at least one of: the display and speaker, the display and computer, and the computer and speaker,
the computer establishing a setting for the speaker based at least in part on a distance between the display and speaker.

18. The system of claim 17, further comprising at least one position generator communicating signals to the computer based on which the computer establishes the setting.

19. The system of claim 18, wherein the position generator includes at least one global positioning system.

20. The system of claim 17, further comprising at least one movable TV stand supporting the display.

21. The system of claim 18, wherein the position generator includes at least one phased micro array.

22. The system of claim 18, wherein the position generator includes at least one ultrasonic generator or at least one electromagnetic waveform generator.
